(19) United States
(12) Patent Application Publication
(10) Pub. No.: US 2005/0223364 A1
(43) Pub. Date: Oct. 6, 2005

(54) Method and apparatus to compact trace in a trace buffer

(76) Inventors: Ramesh V. Peri, Austin, TX (US); Christopher M. Chrulski, Gilbert, AZ (US); Ravi Kolagotla, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/814,374

(22) Filed: Mar. 30, 2004

(51) Int. Cl. G06F 7/38

(52) U.S. Cl. 717/128; 712/227

(57) ABSTRACT

A method and apparatus to compact trace in a trace buffer are described.

### BACKGROUND

A processing system may need a trace system to reproduce executed program instructions. A trace system may generate a trace for a segment of executed program instructions, and store the trace in a trace buffer. In some processing systems, however, the trace buffer may have limited space to store traces. This may result in frequent processing interruptions to empty the trace buffer.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates a system suitable for practicing one embodiment;

FIG. 2 illustrates a block diagram of a trace system in accordance with one embodiment;

FIG. 3 illustrates a block diagram of a trace management module (TMM) in accordance with one embodiment;

FIG. 4 illustrates a block flow diagram of the programming logic performed by a TMM in accordance with one embodiment;

FIG. 5 illustrates an acyclic control flow graph in accordance with one embodiment;

FIG. 6 illustrates an annotated control flow graph in accordance with one embodiment;

FIG. 7A illustrates a path identification register in accordance with one embodiment;

FIG. 7B illustrates an unconditional branch instruction in accordance with one embodiment;

FIG. 7C illustrates a conditional branch instruction in accordance with one embodiment; and

FIG. 8 illustrates generating a path identification value in accordance with one embodiment.

### DETAILED DESCRIPTION

Numerous specific details may be set forth herein to provide a thorough understanding of the embodiments. It will be understood by those skilled in the art, however, that the embodiments may be practiced without these specific details. In other instances, well-known methods, procedures, components and circuits have not been described in detail so as not to obscure the embodiments. It can be appreciated that the specific structural and functional details disclosed herein may be representative and do not necessarily limit the scope of the embodiments.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

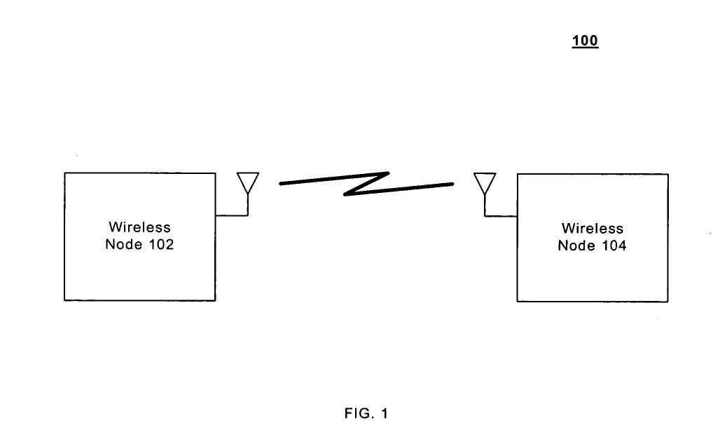

Referring now in detail to the drawings wherein like parts are designated by like reference numerals throughout, there is illustrated in FIG. 1 a system suitable for practicing one embodiment. FIG. 1 is a block diagram of a system 100. System 100 may comprise a plurality of nodes. The term “node” as used herein may refer any element, module, component, board, device or system that may process a signal representing information. The signal may be, for example, an electrical signal, optical signal, acoustical signal, chemical signal, and so forth. The embodiments are not limited in this context.

System 100 may comprise a plurality of nodes connected by varying types of communications media. The term “communications media” as used herein may refer to any medium capable of carrying information signals. Examples of communications media may include metal leads, semiconductor material, twisted-pair wire, co-axial cable, fiber optic, radio frequency (RF) spectrum, and so forth. The terms “connection” or “interconnection,” and variations thereof, in this context may refer to physical connections and/or logical connections. The nodes may connect to the communications media using one or more input/output (I/O) adapters, such as a network interface card (NIC), for example. An I/O adapter may be configured to operate with any suitable technique for controlling communication signals between computer or network devices using a desired set of communications protocols, services and operating procedures, for example. The I/O adapter may also include the appropriate physical connectors to connect the I/O adapter with a suitable communications medium.

In one embodiment, for example, system 100 may be implemented as a wireless system having a plurality of nodes using RF spectrum to communicate information, such as a cellular or mobile system. In this case, one or more nodes shown in system 100 may further comprise the appropriate devices and interfaces to communicate information signals over the designated RF spectrum. Examples of such devices and interfaces may include omni-directional antennas and wireless RF transceivers. The embodiments are not limited in this context.

The nodes of system 100 may be configured to communicate different types of information. For example, one type of information may comprise “media information.” Media information may refer to any data representing content meant for a user, such as data from a voice conversation, videoconference, streaming video, electronic mail (“email”) message, voice mail message, alphanumeric symbols, graphics, image, video, text and so forth. Another type of information may comprise “control information.” Control information may refer to any data representing commands, instructions or control words meant for an automated system. For example, control information may be used to route media information through a system, or instruct a node to process the media information in a predetermined manner. The embodiments are not limited in this context.

The nodes of system 100 may communicate the media or control information in accordance with one or more protocols. The term “protocol” as used herein may refer to a set of instructions to control how the information is communicated over the communications medium. The protocol may be defined by one or more protocol standards, such as the standards promulgated by the Internet Engineering Task Force (IETF), International Telecommunications Union (ITU), a company such as Intel® Corporation, and so forth.

As shown in FIG. 1, system 100 may comprise a wireless communication system having a wireless node 102 and a wireless node 104. Wireless nodes 102 and 104 may comprise nodes configured to communicate information over a wireless communication medium, such as RF spectrum. Wireless nodes 102 and 104 may comprise any wireless device or system, such as mobile or cellular telephone, a computer equipped with a wireless access card or modem, a handheld client device such as a wireless personal digital assistant (PDA), a wireless access point, a base station, a mobile subscriber center, and so forth. In one embodiment, for example, wireless node 102 and/or wireless node 104 may comprise wireless devices developed in accordance with the Personal Internet Client Architecture (PCA) by Intel® Corporation. Although FIG. 1 shows a limited number of nodes, it can be appreciated that any number of nodes may be used in system 100. Further, although the embodiments may be illustrated in the context of a wireless system, the principles discussed herein may also be implemented in a wired communication system as well. The embodiments are not limited in this context.

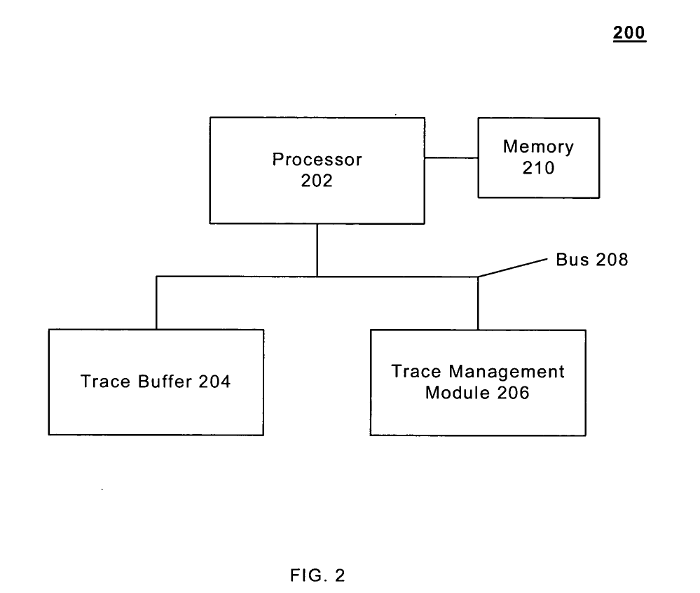

In general operation, wireless nodes 102 and 104 may execute one or more sets of program instructions. The term “program instructions” may include computer code segments comprising words, values and symbols from a predefined computer language that, when placed in combination according to a predefined manner or syntax, cause a processor to perform a certain function. Examples of a computer language may include C, C++, JAVA, assembly and so forth. Consequently, wireless nodes 102 and/or 104 may need a trace system to reproduce program instructions executed by a processor for wireless nodes 102 and/or 104. A trace system for wireless nodes 102 and 104 may be discussed in more detail with reference to FIGS. 2-8.

FIG. 2 may illustrate a trace system in accordance with one embodiment. FIG. 2 may illustrate a trace system 200. Trace system 200 may be representative of, for example, a trace system implemented for wireless nodes 102 and 104. Trace system 200 may comprise one or more modules. Although the embodiment has been described in terms of “modules” to facilitate description, one or more circuits, components, registers, processors, software subroutines, or any combination thereof could be substituted for one, several, or all of the modules. The embodiments are not limited in this context.

As shown in FIG. 2, trace system 200 may comprise a processor 202, a trace buffer 204 and a trace management module (TMM) 206, and a memory 210, all in communication via communication bus 208. Although FIG. 2 shows a limited number of elements, it can be appreciated that any number of additional elements may be used in trace system 200.

In one embodiment, trace system 200 may comprise processor 202. Processor 202 can be any type of processor capable of providing the speed and functionality required by the embodiments. For example, processor 202 could be a processor made by Intel® Corporation and others. Processor 202 may also comprise a digital signal processor (DSP) and accompanying architecture, such as a DSP from Texas Instruments Incorporated. Processor 202 may further comprise a dedicated processor such as a network processor, embedded processor, micro-controller, input/output (I/O) processor, controller and so forth. The embodiments are not limited in this context.

In one embodiment, trace system 200 may comprise memory 210. Memory 210 may comprise a machine-readable medium and may include any medium capable of storing instructions adapted to be executed by a processor. Some examples of such media include, but are not limited to, read-only memory (ROM), random-access memory (RAM), programmable ROM, erasable programmable ROM, electronically erasable programmable ROM, dynamic RAM, magnetic disk (e.g., floppy disk and hard drive), optical disk (e.g., CD-ROM) and any other media that may store digital information. In one embodiment, the instructions are stored on the medium in a compressed and/or encrypted format. As used herein, the phrase “adapted to be executed by a processor” is meant to encompass instructions stored in a compressed and/or encrypted format, as well as instructions that have to be compiled or installed by an installer before being executed by the processor. Further, processor 202 may access various combinations of machine-readable storage devices which are capable of storing a combination of computer program instructions and data through various I/O controllers (not shown). The embodiments are not limited in this context.

In one embodiment, trace system 200 may comprise communication bus 208. Communication bus 208 may be any communication bus suitable for communicating information between elements 202, 204 and 206 at the operating speed identified for a given implementation. The embodiments are not limited in this context.

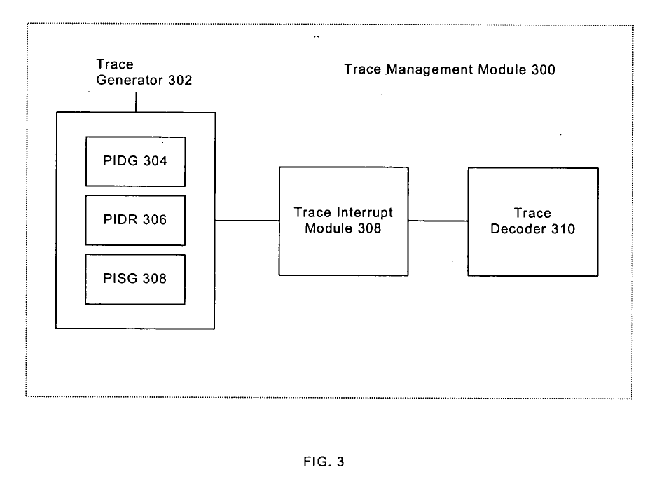

In one embodiment, trace system 200 may comprise TMM 206. TMM 206 may manage trace operations for trace system 200. For example, TMM 206 may operate to generate traces. A “trace” as used herein may refer to a data structure containing information to reproduce executed program instructions. TMM 206 may also store and retrieve traces from trace buffer 204. In addition, TMM 206 may reproduce program instructions executed by processor 202 using a trace. TMM 206 may be discussed in more detail with reference to FIGS. 3-8.

In one embodiment, system 200 may comprise trace buffer 204. Trace buffer 204 may be used to store traces generated by TMM 206. Trace buffer 204 may be a hardware or software buffer, depending on the architecture of wireless nodes 102 and 104, as well as available system resources. Trace buffer 204 will typically have a finite length. In one embodiment, for example, trace buffer 204 may be a hardware trace buffer storing N trace entries. A typical number of trace entries may comprise N=16, for example, although the embodiments are not limited in this context.

FIG. 3 illustrates a block diagram of a TMM in accordance with one embodiment. FIG. 3 illustrates a TMM 300. TMM 300 may be representative of, for example, TMM 206. As shown in FIG. 3, TMM 300 may comprise a trace generator 302, a trace interrupt module 308, and a trace decoder 310. Although FIG. 3 shows a limited number of elements, it can be appreciated that any number of additional elements may be used in TMM 300.

In one embodiment, TMM 300 may comprise trace interrupt module 308. Trace interrupt module 308 may be configured to remove traces from trace buffer 204. Trace interrupt module 308 may provide an interrupt or exception event to remove traces from trace buffer 204. Trace interrupt module 308 may remove traces from trace buffer 204 under a number of different conditions. In one embodiment, for example, trace interrupt module 308 may receive a request from an external source to retrieve one or more traces from trace buffer 204. The external source may comprise an application program, operating system, or component of TMM 300. In one embodiment, for example, trace interrupt module 308 may be configured to remove one or more traces on a periodic basis, such as every M number of processing cycles, clock cycles, and so forth. In one embodiment, for example, trace interrupt module 308 may be configured to monitor trace buffer 204, and remove or “dump” stored traces when trace buffer 204 becomes full or reaches an overflow condition. Trace interrupt module 308 may copy or move traces from trace buffer 204 to some other storage location, such as memory 210, for example. Alternatively, trace interrupt module 308 may be configured to stream out the contents of trace buffer 204 in real-time, which is possible since the traces may be highly compact relative to conventional traces. In this case, the metric may be a value for any of the performance counters present in system 100 or system 200, such as cycle count, branch count, and so forth. The embodiments are not limited in this context.

In one embodiment, TMM 300 may comprise trace generator 302. Trace generator 302 may be configured to generate traces. More particularly, trace generator 302 may generate a trace in a manner that reduces the amount of information needed to be stored in trace buffer 204 as compared to conventional trace generating techniques.

Conventional trace generating techniques may be unsatisfactory for a number of reasons. For example, conventional trace generating techniques typically record program flow by recording discontinuous addresses that occur as a result of changes in the program flow. These changes may be caused by a number of different types of program instructions, such as program call instructions, jump instructions, conditional branch instructions, unconditional branch instructions, interrupts, and so forth. Conventional techniques may record a trace for every discontinuity in a set or subset of program instructions, which may quickly fill up the trace buffer. This may lead to a relatively frequent number of interrupts needed to remove or dump traces from the trace buffer to some other storage location.

Trace generator 302 may solve these and other problems. Trace generator 302 may generate a trace for a subset of program instructions formed from the overall set of program instructions. An example of a set of program instructions may comprise an application program. An example of a subset of program instructions may comprise a function of an application program. In this manner, the number of traces recorded in trace buffer 204 may be proportional to the number of function calls in the program as opposed to the total number of discontinuities in the program. As a result, the number of traces needed for a given set of program instructions may be significantly less than conventional techniques, which in some instances may be several orders of magnitude. For example, conventional trace generating techniques may generate as many as approximately 1.5 million traces for the G723 protocol. By way of contrast, trace generator 302 may generate approximately 62,000 traces for the same G723 protocol. These numbers are by way of example only, and may vary for a given implementation.

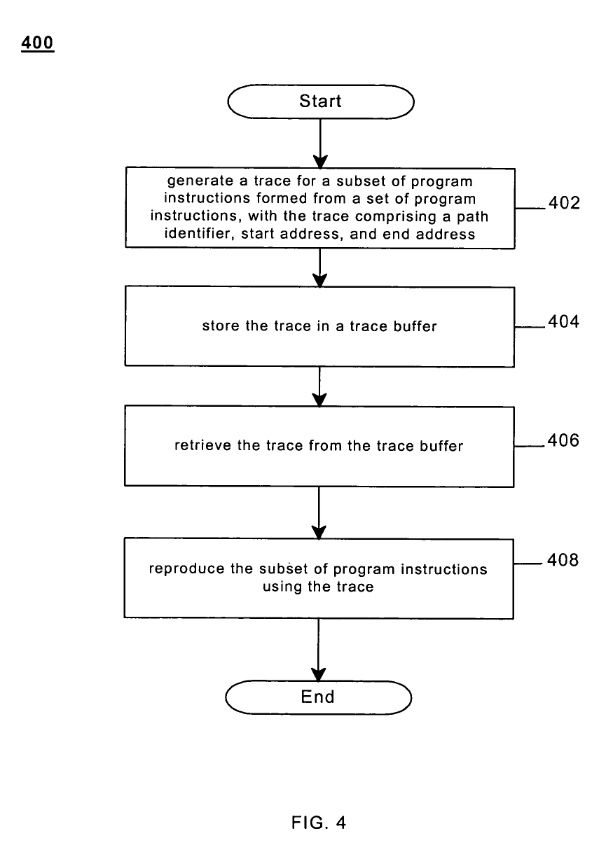

In one embodiment, trace generator 302 may further comprise a path identification generator (PIDG) 304, a path identification register (PIDR) 306, and a program instruction register (PISG) 308. These elements may be discussed in more detail with reference to FIGS. 4-8. Although trace generator 302 shows a limited number of elements, it can be appreciated that any number of additional elements may be used in trace generator 302. The embodiments are not limited in this context.

In one embodiment, TMM 300 may comprise trace decoder 310. Trace decoder 310 may be configured to reproduce executed program instructions using a trace. Trace decoder 310 may retrieve a trace from trace buffer 204 or memory 210. Trace decoder 310 may decode the executed program instructions for a function using the trace.

The operations of systems 100-300 may be further described with reference to FIGS. 4-8 and accompanying examples. Although FIG. 4 as presented herein may include a particular programming logic, it can be appreciated that the programming logic merely provides an example of how the general functionality described herein can be implemented. Further, the given programming logic does not necessarily have to be executed in the order presented unless otherwise indicated. In addition, although the given programming logic may be described herein as being implemented in the above-referenced modules, it can be appreciated that the programming logic may be implemented anywhere within the system and still fall within the scope of the embodiments.

FIG. 4 illustrates a programming logic for a TMM in accordance with one embodiment. FIG. 4 illustrates a programming logic 400 that may be representative of the operations executed by TMM 300 in accordance with one embodiment. As shown in programming logic 400, a trace for a subset of program instructions formed from a set of program instructions may be generated at block 402. The trace may comprise, for example, a path identifier value, start address, and end address. The path identifier value may comprise a unique value identifying a path of program instructions within a function. The start address may comprise an instruction address for the beginning of a path. The end address may comprise an instruction address for the end of a path. The trace may be stored in a trace buffer at block 404. The trace may be retrieved from the trace buffer at block 406. The subset of program instructions may be reproduced using the trace at block 408.

In one embodiment, the trace may be generated at block 402 by receiving an endpoint program instruction for the subset of program instructions. The endpoint program instruction may be any terminating instruction, such as a function return or function exit instruction. The path identifier value and end address for the subset of program instructions may be generated. A start address may be retrieved from a program counter register. The trace may be generated using the path identifier value, start address and end address.

In one embodiment, the path identifier value and end address may be generated by initializing a path identifier register. The path identifier register may be configured to store an end address and a path identifier value. Each unconditional branch instruction for the set of program instructions may be assigned an unconditional partial path value and an unconditional offset value. Each conditional branch instruction for the set of program instructions may be assigned a taken branch partial path value, an untaken branch partial path value, and a conditional offset value.

In one embodiment, the path identifier value and end address may be further generated by receiving a branch instruction. A determination may be made as to whether the branch instruction is a conditional branch instruction or unconditional branch instruction. If the branch instruction is an unconditional branch instruction, the path identifier value stored in the path identification register may be incremented with the unconditional partial path value, and the end address stored in the path identification register may be incremented with the unconditional offset value. If the branch instruction is a conditional branch instruction that was taken, the path identifier value may be incremented with the taken branch partial path value, and the end address may be incremented with the conditional offset value. If the branch instruction is a conditional branch instruction that was untaken, the path identifier value may be incremented with the untaken branch partial path value, and the end address may be incremented with the conditional offset value.

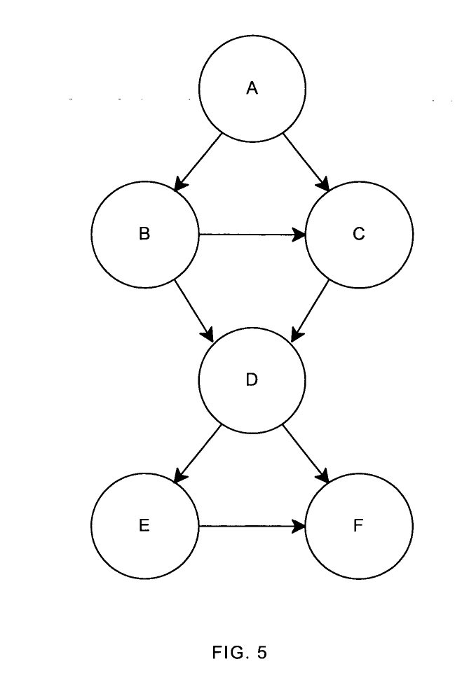

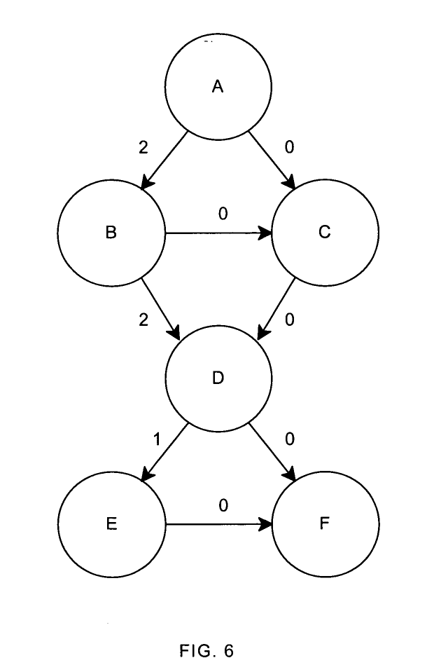

The operation of systems 100-300, and the programming logic shown in FIG. 4, may be better understood by way of example. Assume an application program is to be executed by a processing system for wireless node 102. The application program may be comprised of a plurality of modules or functions. Each function may have different types of branch instructions, such as program call instructions, jump instructions, conditional branch instructions, unconditional branch instructions, interrupts, and so forth. These types of program instructions may create different paths through the function. Trace system 200 may generate a plurality of traces, with each trace representing a path of program instructions within a program or function. Each trace may comprise a path identification value, start address and end address. The path identification value may be generated using an acyclic control flow graph, as described in more detail with reference to FIGS. 5 and 6.

FIG. 5 illustrates an acyclic control flow graph in accordance with one embodiment. FIG. 5 illustrates an acyclic control flow graph for a first program as follows:

```
A: . . .
  If (CC) jump B;
C: . . .
  Jump D;
B: . . .
  If (CC) jump C;
D: . . .
  If (CC) jump F;
E: . . .
  Jump F;
F: . . .
```

The control graph shown in FIG. 5 may have a plurality of nodes A-F. Each node A-F may comprise a basic block of program instructions having no branch instructions. The arrows between the nodes may comprise edges representing jumps between nodes.

FIG. 6 illustrates an annotated control flow graph in accordance with one embodiment. Once a control flow graph for the function is generated, each jump may be assigned a partial path value. The partial path value may comprise a number associated with an edge of the control graph. The partial path values may be generated using the following algorithm:

```
For each vertex v in the control flow graph in reverse topological order {
  If v is a leaf vertex then {
    Num_Paths(v) = 1;
  } else {
    Num_Paths(v) = 0;
    For each edge e = v -> w {
      Val(e) = Num_Paths(v);
      Num_Paths(v) = Num_Paths(v) + Num_Paths(w);
    }
  }
}
```

Using the above algorithm, each edge of the control flow graph may be annotated with a partial path value as shown in FIG. 6.

FIG. 6 illustrates an annotated control flow graph in accordance with one embodiment. The partial path values may be used to generate a path identification value for each path through the function. Various paths and their corresponding path identification values may be illustrated in Table 1 as follows:

TABLE 1

| Path | Path Identification Value |
|---|---|
| acdf | 0 |
| acdef | 1 |
| abcdf | 2 |
| abcdef | 3 |
| abdf | 4 |
| abdef | 5 |

By way of example, the path “acdf” has a path identification value of 0. If you traverse path “acdf” through the control flow graph shown in FIG. 6, you accumulate the partial path value 0 for the jump between A and C, the partial path value 0 for the jump between C and D, and the partial path value 0 for the jump between D and F. By summing the partial path values for “acdf”, you get a path identification value of 0. In another example, the path “abdef” has a path identification value of 5. If you sum all the partial path values for the path “abdef”, you get a path identification value of 5. In this manner, each path through the function may have a unique identifier. The unique identifier may be used to reproduce the nodes and associated program instructions for each path.

At least two significant principles are described above. The first is that given an acyclic control flow graph annotated with partial path values, the number of paths from A to EXIT is Num_Paths(a), and each path from A to EXIT generates a unique value sum in the range of 0 . . . Num_Paths(a)−1. The second is that given an acyclic control flow graph, the number of paths from node A to node B is Num_Paths(a,b), and each path from A to B generates a unique value sum in the range 0 . . . Num_Paths(a), where Num_Paths(a) is the number of paths from A to EXIT.

These two principles may be confirmed using the following proof. Assume there are two paths pa1 and pa2 from A to B which have the same value sum denoted by x. Select any path pb from B to EXIT whose value is y. Now the paths pa1+pb and pa2+pb will be unique paths from A to EXIT with same value x+y. This violates theorem 1 and hence the initial assumption that there exists two paths pa1 and pa2 between A and B having the same value is not true.

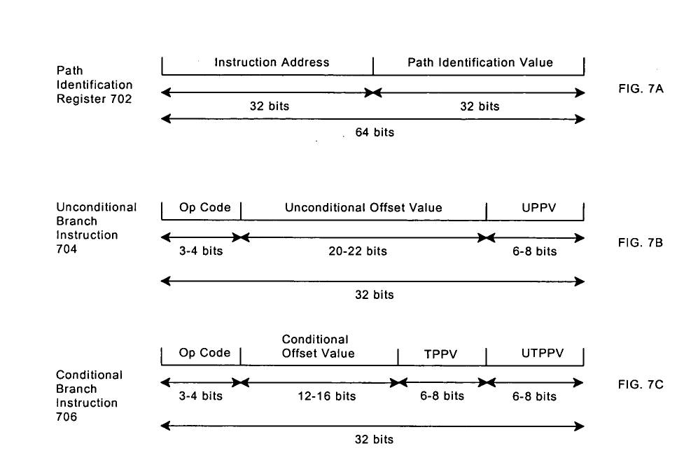

FIGS. 7A-C may illustrate a path identification register, unconditional branch instruction and conditional branch instruction in accordance with one embodiment. Once the partial path values are assigned to the control flow graph, a path identification value for a given path executed by processor 202 may be generated using PIDR 306.

FIG. 7A illustrates a path identification register in accordance with one embodiment. FIG. 7A illustrates a path identification register 702. In one embodiment, path identification register 702 may be representative of, for example, PIDR 306. Path identification register 702 may comprise a register maintained by the system registry. PIDR 306 may comprise two fields: (1) an instruction address field to store an instruction address; and (2) a path identification value field to store a path identification value. Initially, the instruction address may comprise the start address of the path in the path identification value field of path identification register 702. In one embodiment, the instruction address may comprise 32 bits, and the path identification value may comprise 32 bits, thus path identification register 702 may comprise 64 bits in total. The bit numbers are used by way of example only, and the embodiments are not limited in this context. The contents of PIDR 306 may be effected by a branch instruction, such as an unconditional branch instruction, conditional branch instruction, call instruction, and return instruction.

FIG. 7B illustrates an unconditional branch instruction in accordance with one embodiment. FIG. 7B illustrates an unconditional branch instruction 704. As shown in FIG. 7B, unconditional branch instruction 704 may comprise an operation code field having 3-4 bits, an unconditional offset value field having 20-22 bits, and an unconditional partial path value field having 6-8 bits. The total number of bits for unconditional branch instruction 704 may therefore comprise 32 bits, although the embodiments are not limited in this context. The operation code field may store an operational code value to represent the type of operation, such as a branch instruction, add instruction, and so forth. The unconditional offset value field may store an unconditional offset value to represent a value to be added to the current program counter to derive the address of the target instruction to which program flow control is moving. The unconditional partial path value may comprise the partial path value of the edge being traversed between nodes.

It is worthy to note that the number of bits allocated to specifying the offsets that need to be added to path identification register 702 may determine the maximum path length that can be represented at a time. If this value is set to 1, then trace system 200 may be configured to default into recording every control flow transfer, similar to conventional trace techniques.

FIG. 7C illustrates a conditional branch instruction in accordance with one embodiment. FIG. 7C illustrates a conditional branch instruction 706. As shown in FIG. 7C, conditional branch instruction 706 may comprise an operation code field having 3-4 bits, a conditional offset value field having 12-16 bits, a taken branch partial path value field having 6-8 bits, and an untaken branch partial path value field having 6-8 bits. The operation code field may store an operation code similar to the one described with reference to FIG. 7B. The conditional offset value field may store an offset value similar to the one described with reference to FIG. 7B. The taken branch partial path value field may store a partial path value for an edge taken when the condition in the conditional branch instruction is satisfied. The untaken branch partial path value field may store a partial path value for an edge taken when the condition in the conditional branch instruction is not satisfied.

Path identification register 702 may be used as follows when a call instruction and return instruction are received. When a call instruction is received, path identification register 702 is treated similar to the return address register. Its value is saved on the call frame stack and is initialized to zero. The call frame stack may be a stack allocated by the compiler based upon a number of factors, such as the number of local variables, temporary locations needed by a function, and so forth. When a return instruction is received, path identification register 702 is written into trace buffer 204 and the previous value of the path identification value which corresponds to the partial path taken in the calling function is restored.

Once the unique path identification information is generated for an application program or function of an application program, the path identification information may be assigned in the branch instructions. For example, the first program described previously may be modified by the compiler as shown in the second program below:

```
A: . . .
  If (CC) jump B (2, 0);
C: . . .
  Jump D (0);
B: . . .
  If (CC) jump C (0, 2);
D: . . .
  If (CC) jump F (0, 1);
E: . . .
  Jump F (0);
F: . . .
```

As shown in the second program, the conditional branch instructions have been assigned two new values, the first being a partial path value for a taken branch, and the second being a partial path value for an untaken branch. The partial path values may be used to generate a path identification value for a path of executed program instructions.

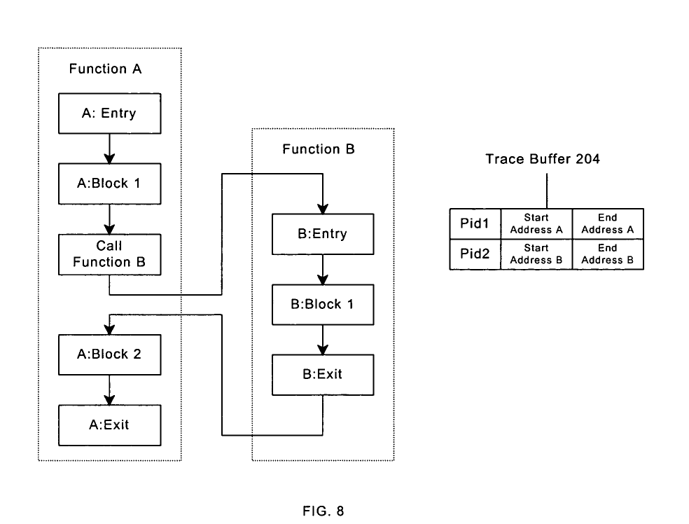

FIG. 8 illustrates generating a path identification value in accordance with one embodiment. FIG. 8 shows the program flow for a function A and a function B, and an example for trace buffer 204. Function A begins execution with A:Entry, and moves to A:Block 1. After executing A:Block 1, function A executes a call instruction Call Function B. Program control moves to function B. Function B begins execution with B:Entry, and moves to B:Block 1. After executing B:Block 1, function B executes a return instruction B:Exit. Program control is returned to function A, which proceeds to execute A:Block 2 and A:Exit prior to terminating the path.

As shown in FIG. 8, trace buffer 204 may store a plurality of traces for function A and function B, with each trace representing a path through the function. Trace buffer 204 may contain a sequence of entries as shown in Table 2 as follows:

TABLE 2

| | Entry 1 | Entry 2 | Entry N |
|---|---|---|---|
| Path ID Value | Pid1 | Pid2 | PidN |
| Start Address | Start Address A | Start Address B | Start Address N |
| End Address | End Address A | End Address B | End Address N |
| Metric | 10 processing | 20 processing | P processing |
| | cycles | cycles | cycles |

As shown in Table 2, trace buffer 204 may have multiple entries 1-N, with each entry having a path identification value, a start address, an end address, and a metric. The metric may comprise, for example, any desired metric to measure performance of system 100 or trace system 200, or to assist in troubleshooting either system. Examples of suitable metrics may comprise total number of processing cycles, branch instructions, taken branches, not taken branches, and so forth. The embodiments are not limited in this context.

Referring again to FIG. 8, the trace may be generated when a return instruction is executed by processor 202. For example, once Call Function B has been executed, trace system 200 may save the current contents of path identification register 702 onto a stack. Once B:Exit has been executed, trace system 200 may save the contents of path identification register 702 represented by Pid2 in trace buffer 204. Trace system 200 may then restore the callers' (e.g., function A) path identification information from the stack. Once A:Exit has been executed, trace system 200 may save the contents of path identification register 702 represented by Pid1 in trace buffer 204.

Once the traces have been generated, trace decoder 310 may reproduce the complete control flow using the path identification value, start address and end address for each trace.

In one embodiment, trace system 200 may be modified to handle loops with backward branches. In this case, the conditional branch instruction may be enhanced to initialize the path identification value to zero, and make an entry into trace buffer 204 in addition to the ability to add a specified value to path identification register 702. This may be used for back edges of loops. It is worthy to note that there may be multiple entries for each iteration of the loop corresponding to the back edge, the complete path information inside the loop is represented as path identification values providing good compression. If there is only one path inside the loop then one entry may be made in trace buffer 204 rather than multiple entries. This may be detected by comparing the previous entry with the entry about to be written.

In one embodiment, trace system 200 may also be modified to use a check point instruction. The check point instruction may explicitly dump the contents of path identification register 702 into trace buffer 204 and initialize it to zero. This may be useful when the total number of paths in a function is extremely large and path identification register 702 may potentially overflow.

The embodiments may be implemented using an architecture that may vary in accordance with any number of factors, such as desired computational rate, power levels, heat tolerances, processing cycle budget, input data rates, output data rates, memory resources, data bus speeds and other performance constraints. For example, one embodiment may be implemented using software executed by a processor. The processor may be a general-purpose or dedicated processor, such as a processor made by Intel® Corporation, for example. The software may comprise computer program code segments, programming logic, instructions or data. The software may be stored on a medium accessible by a machine, computer or other processing system. Examples of acceptable mediums may include computer-readable mediums as previously described. In one embodiment, the medium may store programming instructions in a compressed and/or encrypted format, as well as instructions that may have to be compiled or installed by an installer before being executed by the processor. In another example, one embodiment may be implemented as dedicated hardware, such as an Application Specific Integrated Circuit (ASIC), Programmable Logic Device (PLD) or Digital Signal Processor (DSP) and accompanying hardware structures. In yet another example, one embodiment may be implemented by any combination of programmed general-purpose computer components and custom hardware components. The embodiments are not limited in this context.

While certain features of the embodiments have been illustrated as described herein, many modifications, substitutions, changes and equivalents will now occur to those skilled in the art. It is, therefore, to be understood that the appended claims are intended to cover all such modifications and changes as fall within the true spirit of the embodiments.

1. A method, comprising:
generating a trace for a subset of program instructions formed from a set of program instructions, with said trace comprising a path identifier value, start address, and end address;
storing said trace in a trace buffer;
retrieving said trace from said trace buffer; and
reproducing said subset of program instructions using said trace.

2. The method of claim 1, wherein generating said trace comprises:
receiving an endpoint program instruction for said subset of program instructions;
generating said path identifier value and end address for said subset of program instructions;
retrieving said start address from a program counter register; and
generating said trace using said path identifier value, start address and end address.

3. The method of claim 2, wherein generating said path identifier value and end address comprises:
initializing a path identifier register, with said path identifier register to store said end address and said path identifier value;
assigning each unconditional branch instruction for said set of program instructions an unconditional partial path value and an unconditional offset value; and
assigning each conditional branch instruction for said set of program instructions a taken branch partial path value, an untaken branch partial path value, and a conditional offset value.

4. The method of claim 3, wherein said generating said path identifier value and end address further comprises:
receiving a branch instruction;
determining whether said branch instruction is a conditional branch instruction or unconditional branch instruction;
incrementing said path identifier value with said unconditional partial path value and said end address with said unconditional offset value if said branch instruction is an unconditional branch instruction;
incrementing said path identifier value with said taken branch partial path value and said end address with said conditional offset value if said branch instruction is a conditional branch instruction that was taken; and
incrementing said path identifier value with said untaken branch partial path value and said end address with said conditional offset value if said branch instruction is a conditional branch instruction that was untaken.

5. The method of claim 4, further comprising initializing said path identifier register prior to processing another conditional branch instruction.

6. The method of claim 1, wherein said subset of program instructions comprises a function.

7. The method of claim 3, wherein said path identifier and end address each comprise 32 bits.

8. The method of claim 3, wherein said conditional branch instruction and said unconditional branch instruction each comprise 32 bits.

9. The method of claim 3, wherein said conditional branch instruction and said unconditional branch instruction further comprise a operation code value to identify a type of instruction.

10. The method of claim 1, wherein said trace buffer comprises N entries, and further comprising moving traces from said trace buffer to another storage location after storing N entries.

11. An apparatus, comprising:
a trace buffer to store traces; and
a trace management module to couple to said trace buffer, said trace management module to further comprise a trace generator to generate a trace for a subset of program instructions formed from a set of program instructions, with said trace comprising a path identifier value, start address, and end address, said trace management module to store each generated trace in said trace buffer.

12. The apparatus of claim 11, wherein said trace management module further comprises a trace interrupt module to remove traces from said trace buffer.

13. The apparatus of claim 11, wherein said trace management module further comprises a trace decoder to reproduce said subset of program instructions using said trace.

14. The apparatus of claim 11, wherein said trace generator further comprises:
a path identifier register;
a program counter register; and
a path identifier generator operatively coupled to said path identifier register and said program counter register, said path identifier generator to receive an endpoint program instruction for said subset of program instructions, to generate said path identifier value and end address for said subset of program instructions using said path identifier register, to retrieve said start address from a program counter register, and generate said trace using said path identifier value, start address and end address.

15. A system, comprising:
a wireless device to process information, said wireless device comprising:
a trace buffer to store traces;
a processor to couple to said trace buffer, said processor to process a subset of program instructions formed from a set of program instructions;
a trace management module to couple to said processor and said trace processor, said trace management module to further comprise a trace generator to generate a trace for said subset of program instructions, with said trace comprising a path identifier value, start address, and end address, said trace management module to store each generated trace in said trace buffer; and
an antenna to communicate said information over radio frequency spectrum.

16. The apparatus of claim 15, wherein said trace management module further comprises a trace interrupt module to remove traces from said trace buffer.

17. The apparatus of claim 15, wherein said trace management module further comprises a trace decoder to reproduce said subset of program instructions using said trace.

18. The apparatus of claim 15, wherein said trace generator further comprises:
a path identifier register;
a program counter register; and
a path identifier generator operatively coupled to said path identifier register and said program counter register, said path identifier generator to receive an endpoint program instruction for said subset of program instructions, to generate said path identifier value and end address for said subset of program instructions using said path identifier register, to retrieve said start address from a program counter register, and generate said trace using said path identifier value, start address and end address.

19. An article comprising:
a storage medium;
said storage medium including stored instructions that, when executed by a processor, result in generating a trace for a subset of program instructions formed from a set of program instructions, with said trace comprising a path identifier value, start address, and end address, storing said trace in a trace buffer, retrieving said trace from said trace buffer, and reproducing said subset of program instructions using said trace.

20. The article of claim 19, wherein the stored instructions, when executed by a processor, further result in generating said trace by receiving an endpoint program instruction for said subset of program instructions, generating said path identifier value and end address for said subset of program instructions, retrieving said start address from a program counter register, and generating said trace using said path identifier value, start address and end address.
